(19) United States
(12) Patent Application Publication
(10) Pub. No.: US 2011/0029928 A1
(43) Pub. Date: Feb. 3, 2011

(54) SYSTEM AND METHOD FOR DISPLAYING INTERACTIVE CLUSTER-BASED MEDIA PLAYLISTS

(75) Inventors: William Martin Bachman, San Jose, CA (US); Brian Frick, Gaithersburg, MD (US)

Correspondence Address: Apple Inc., 1000 Louisiana Street, Fifty-Third Floor, Houston, TX, 77002, US

(73) Assignee: Apple Inc., Cupertino, CA (US)

(21) Appl. No.: 12/533,330

(22) Filed: Jul. 31, 2009

(51) Int. Cl. G06F 3/048

(52) U.S. Cl. 715/841; 715/810

(57) ABSTRACT

Disclosed herein are systems, computer-implemented methods, and tangible computer-readable media for generating cluster-based media playlists. The system includes an input module configured receive a user selection of a seed media object, a selection module selects media objects based on similarity data between the media objects and the seed media object, a ranking module generates a ranking of the media objects, and an output module positions and displays the media objects in a cluster around the seed media object. The method includes receiving a user selection of a seed media object, selecting media objects based on similarity data between the media objects and the seed media object, generating a ranking of the media objects, and displaying the media objects in a cluster around the seed media object.

### BACKGROUND

1. Technical Field

The present application relates to graphical user interfaces and more specifically to a graphical user interface for presenting a media list.

2. Introduction

With the advent of digital audio and or video players, people are accumulating vast libraries of digital media. In many cases, personal media libraries include songs or video added from both online media stores and physical media such as CD, SACD, and DVD-A. While digital audio players have allowed people to enjoy their media virtually anywhere, growing media libraries are more and more difficult to effectively manage. In the instance of music, playlists are one way to effectively manage and filter certain songs. Various digital media players allow for creation of playlists by selecting groupings of songs for ordered playback.

Handcrafting a playlist typically involves the tedious process of searching through a long list of media to find appropriate songs, selecting the desired songs, and hoping that no desirable songs are overlooked. This playlist generation method is laborious, slow, and prone to user error.

Music playlists can also be automatically generated based on common music track attributes, such as genre, artist, album, and the like. These automatically generated playlists, while simple and fast to create, paint playlists with broad strokes. They are often over and/or under inclusive. Further, such automatic methods assume that all relevant track attributes are available and accurate for each piece of media. One way of generating automatic playlists is called a “smart” playlist. A smart playlist allows a user to specify search criteria, adds songs matching the search criteria to the playlist, and automatically update the playlist as songs either meet or fail to meet the criteria. Smart playlists are powerful tools in managing a media library.

However, even smart playlists are limited by a user's musical familiarity, library, and skill in crafting an effective smart playlist query. A user can not be familiar with a style of music. That unfamiliarity can lead to excluding relevant artists or songs. A user's library can be incomplete, leading to a gap in an otherwise complete smart playlist. A user can not craft a smart playlist query broadly enough to include all desired songs. Verifying that a smart playlist includes all intended songs can often be more tedious than having manually generated a playlist in the first place.

Once a playlist has been generated, displaying the playlist effectively along with all of the relevant media information is the next hurdle. Displaying additional information is not the only challenge; program application developers are also challenged to present information in a visually appealing and easily useable way. Lists and icons have long been key elements in achieving these objectives, but while they represent simple ways to present information, they are not sufficiently appealing to consumers and fail to convey enough information to a user.

### SUMMARY

Additional features and advantages will be set forth in the description which follows, and in part will be obvious from the description, or can be learned by practice of the disclosed embodiments. The features and advantages can be realized and obtained by means of the instruments and combinations particularly pointed out in the appended claims. These and other features will become more fully apparent from the following description and appended claims, or can be learned by the practice of the embodiments as set forth herein.

Disclosed are computer-implemented methods, systems, and tangible computer-readable media for generating and displaying cluster-based playlists. The method, in one embodiment, includes receiving a user selection of a seed media object, selecting media objects from a media library based on similarity data between the seed media object and each of the media objects, generating a ranking of the media objects according to the similarity data, and displaying the media objects in a cluster around the seed media object.

In another embodiment, the method includes receiving a user selection of one of the displayed media objects and displaying a new cluster of media objects around the selection. In this embodiment, the user selected media object becomes a new seed media object and the media objects of the new cluster are selected and ranked based on the similarity data between the new seed media object and the media objects of the new cluster. The similarity data can be generated based upon a determined incidence of co-occurrence of pairs of individual media objects across multiple users' media libraries.

The method can include receiving similarity data from an online data processing center and selecting media objects from a user media library, selecting media objects from an online media provider, or selecting media objects from both the user media library and the online media provider. The method can also include, with reference to positioning a media object, selecting a distance and angle with respect to the seed media object based on the ranking. In another embodiment, the method includes identifying which media objects are from the user library and which media objects are from the online media provider. In this manner, the user can easily view media objects in the cluster that are in their personal media library and which media objects can be purchased from an online store.

The system, in one embodiment, includes a processor, memory, software modules as will be shown in FIG. 1. In a further embodiment, the system includes an input module, a selection module, a ranking module, and an output module. These various modules are configured to control a processor in the system to perform certain functions; these functions will be discussed below. The input module receives a user selection of a seed media object from a client device. The selection module selects more than one media object from a media library based on similarity data between the seed media object and each selected media object. The ranking module generates a ranking of the media objects according to the similarity data. The output module transmits data to the client device for display of the media objects in a group around the seed media object.

In a further embodiment, the input module receives an identification from the user of a desire to download at least one media object displayed in the cluster from the online media library, and the output module transmits the identified media object to the user. The ranking module generates a playlist formed of the seed media object and the selected media objects.

The tangible computer readable media, in one embodiment, includes a computer program product having computer executable instructions to perform operation for managing presentation to and selection of media objects. The operations can include receiving a user selection of a level 0 object, displaying multiple level 1 objects adjacent to or around the level 0 object, displaying multiple level 2 objects adjacent to or around each level 1 object, and visually differentiating between the level 0 object, level 1 objects, and level 2 objects. Differentiating between level 0, level 1, and level 2 objects can include displaying each level with different size, color, opacity, and included information. In one case, the level 0 object is a seed media object selected by the user. The level 1 objects are a first level of ranked and related media objects that surround or are displayed adjacent to the level 0 seed media object. In this manner, the user can easily view the related level 1 objects to the selected seed media objects.

### BRIEF DESCRIPTION OF THE DRAWINGS

In order to describe the manner in which the above-recited and other advantages and features of the disclosure can be obtained, a more particular description above will be rendered by reference to specific embodiments thereof which are illustrated in the appended drawings. Understanding that these drawings depict only exemplary embodiments and are not therefore to be considered to be limiting of its scope, this disclosure will provide with additional specificity and detail through the use of the accompanying drawings in which:

FIG. 1 is a schematic block diagram illustrating one example system embodiment;

FIG. 2 is a schematic block diagram illustrating one embodiment of a system for generating and displaying cluster-based media;

FIG. 3 is a schematic block diagram illustrating another embodiment of the system for generating and displaying cluster-based media;

FIG. 4 is a schematic block diagram illustrating one embodiment of a cluster;

FIG. 5 is a schematic block diagram illustrating another embodiment of a cluster;

FIG. 6 is a schematic block diagram illustrating another embodiment of a cluster;

FIG. 7 is a schematic block diagram illustrating another embodiment of a cluster;

FIG. 8 is a schematic flow chart diagram illustrating one example of a method of clustering media objects; and

FIG. 9 is a schematic flow chart diagram illustrating one example of a method of managing presentation to a client device of a group of media objects.

### DETAILED DESCRIPTION

Various embodiments are discussed in detail below. While specific implementations are discussed, it should be understood that this is done for illustration purposes only. A person skilled in the relevant art will recognize that other components and configurations can be used without parting from the spirit and scope of this disclosure.

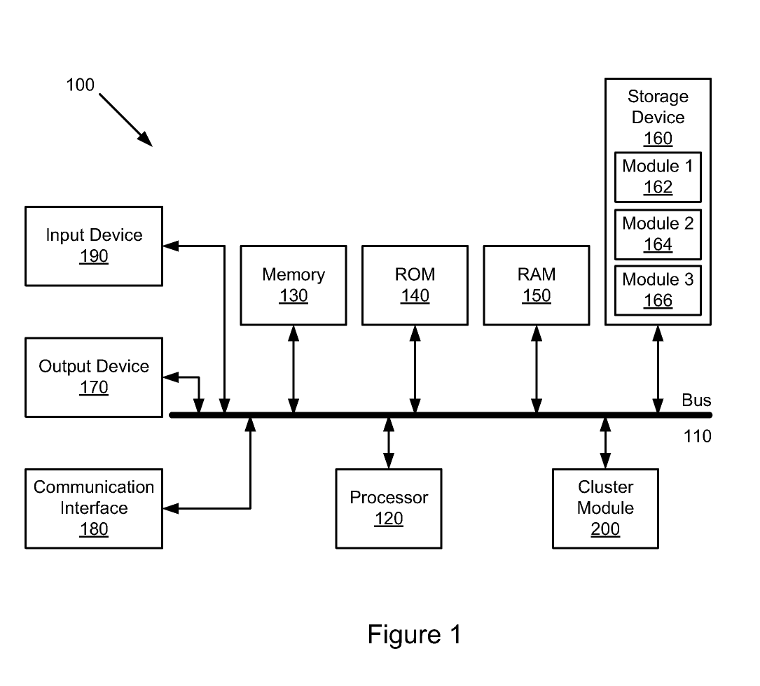

With reference to FIG. 1, an exemplary system includes a general-purpose computing device 100, including a central processing unit (CPU) or processor 120 and a system bus 110 that couples various system components including the system memory 130 such as read-only memory (ROM) 140 and random access memory (RAM) 150 to the processor 120. These and other modules can be configured to control the processor 120 to perform various actions. Other system memory 130 may be available for use as well. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 to perform certain steps, as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 can be any of several types of bus structures including a memory bus or memory controller, a peripheral bus, and a local bus using any of a variety of bus architectures. A basic input/output (BIOS) stored in ROM 140 or the like, can provide the basic routine that helps to transfer information between elements within the computing device 100, such as during start-up. The computing device 100 further includes storage devices such as a hard disk drive 160, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a tangible and/or intangible computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Tangible computer-readable storage media expressly exclude media such as energy, carrier signals, electromagnetic waves, and signals per se.

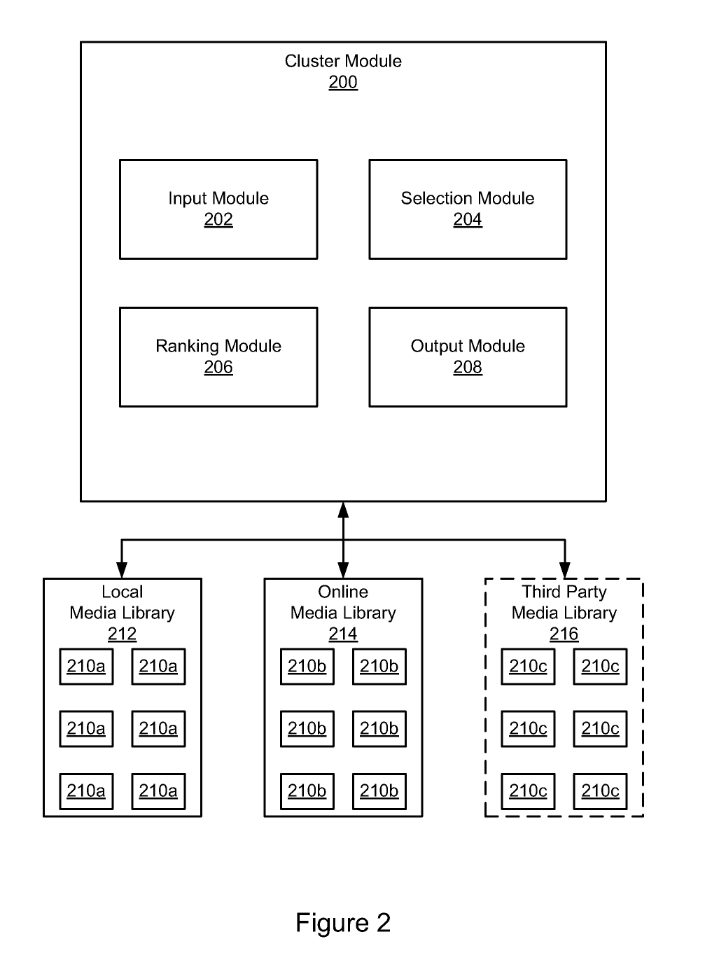

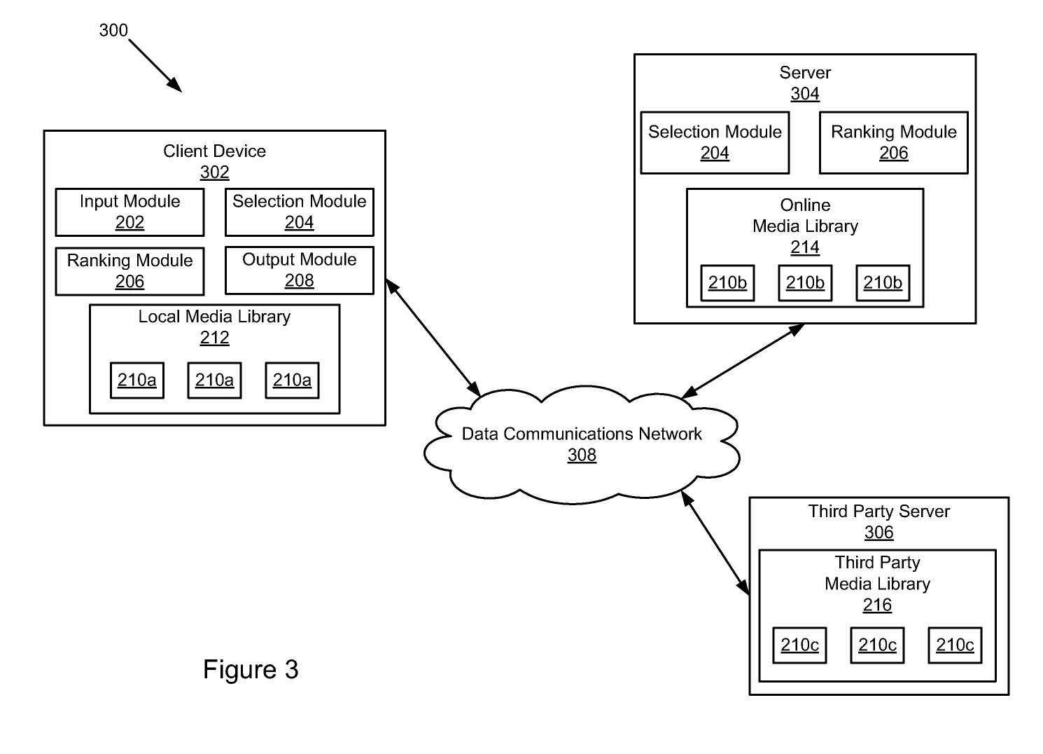

To enable user interaction with the computing device 100, an input device 190 represents any number of input mechanisms, such as a microphone for speech, a touch-sensitive screen for gesture or graphical input, keyboard, mouse, motion input, speech and so forth. The input device 190 may be used by the presenter to indicate the beginning of a speech search query. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed. The general-purpose computing device 100 can also include a cluster module 200 which will be discussed in greater detail below with reference to FIGS. 2 and 3.

For clarity of explanation, the illustrative system embodiment is presented as comprising individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited tangible computer-readable storage media. Generally speaking, such logical operations can be implemented as modules configured to control the processor 120 to perform particular functions according to the programming of the module. For example, FIG. 1 illustrates three modules Module 1 162, Module 2 164 and Module 3 166 which are modules configured to control the processor 120. These modules may be stored on the storage device 160 and loaded into RAM 150 or memory 130 at runtime or may be stored as would be known in the art in other computer-readable memory locations. Likewise, other modules discussed below with reference to FIGS. 2-9 may be stored on the storage device 160 and loaded into RAM 150 or memory 130 at runtime.

FIG. 2 is a schematic block diagram illustrating one embodiment of a system for generating and displaying cluster-based media playlists. The system, in one embodiment, includes a cluster module 200 capable of operating on a computing device such as the general purpose computing device 100 of FIG. 1. Alternatively, the cluster module 200 operates on any device having a processor. Examples of devices having processors include, but are not limited to, laptops, desktops, hand held computing devices, cellular phones, portable media players, in-car computing systems, in-car stereos, etc.

The cluster module 200, in one embodiment, can include an input module 202, a selection module 204, a ranking module 206, and an output module 208. As described previously, these modules can be configured to control a processor to perform certain functions or steps, the functions or steps will now be discussed. The input module 202, in one embodiment, receives a user selection of a media object 210a, 210b, 210c from at least one of the media libraries 212, 214, 216. Examples of a media object 210a, 210b, 210c include, but are not limited to, audio, video, still pictures, documents, any combination of the preceding formats, and other types of data files. Although the media library 212, as depicted, is a collection of media objects 210a, 210b, 210c that appear identical, one skilled in the art will recognize that each instance of a media object 210a, 210b, 210c in the media library 212 is representative of a unique media object, for example, a song or a video.

In a further embodiment, the media library 212 can include local and remote media objects 210a, 210b, 210c. In other words, the media library 212 can be a collection of local media objects stored on the general purpose computing device 100 of FIG. 1 together with media objects 210a, 210b, 210c available for purchase from a remote media store accessible over a data communications network. In one embodiment, the remote media store is iTunes® and the data communications network is the Internet.

Alternatively, the cluster module 200 communicates with an online media library 214, and a third party media library 216. For example, if the online media library 214 is a service provided by iTunes®, the cluster module 200 also communicates with a music store provided by Amazon®. Communicating with online media libraries 214, 216 will be discussed in greater detail below with reference to FIG. 3.

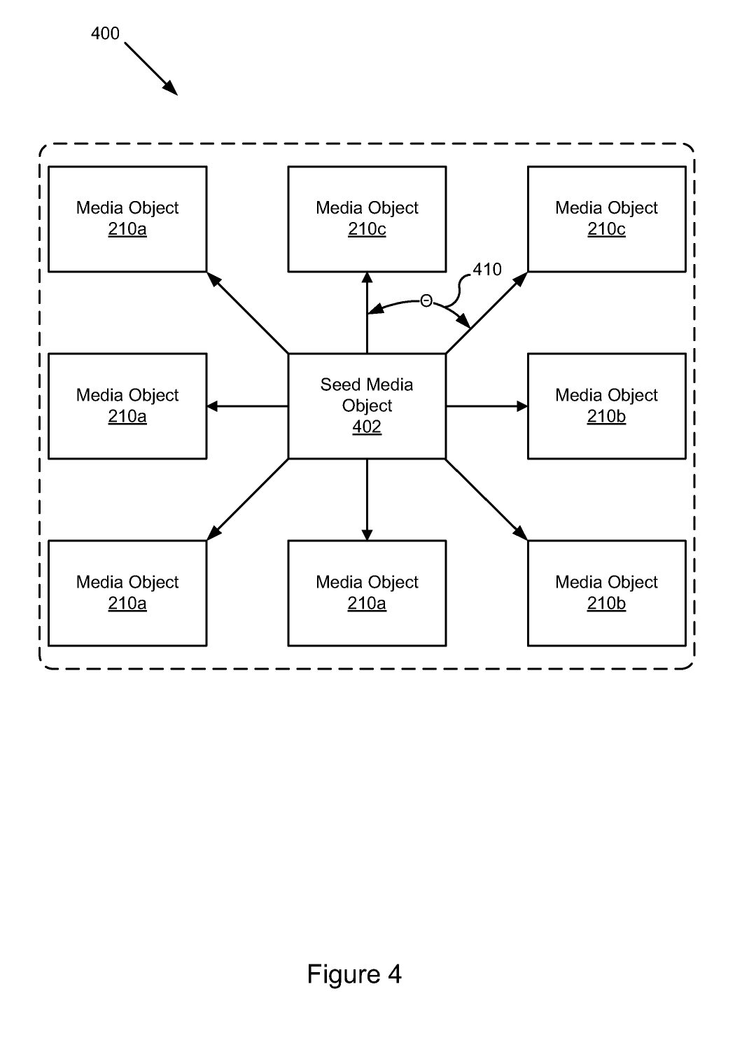

The input module 202, in a further embodiment, receives the user selection through any of the input or communication devices described above with reference to FIG. 1. For example, a user can select a media object by clicking on the media object or dragging the media object to a predetermined location on a screen as will be described in greater detail below with reference to FIGS. 4-6. Alternatively, the input module 202 receives a user selection in the form of a file path, or in the form of output from another program operatively coupled with the system of either FIGS. 1 or 2.

The selection module 204, in one embodiment, selects media objects 210a from the media library 212 based upon similarities between the user selected media object, or seed media object, and media objects 210a in the media library 212. The selection module 204 can base the similarities between the seed media object and the media objects 210a of the media library 212 on a mathematical analysis to determine the incidence of co-occurrence of two or more songs across multiple users' media libraries. Based on how often two or more media items co-occur in the libraries of the entire audience of users, media objects become correlated to each other and are assigned similarity data. The mathematical analysis across the media libraries of multiple users can be performed on a remote data processing host (not shown). For example, the remote data processing host can be a feature of a remote media store accessible over a data communications network.

In a further embodiment, the selection module 204 performs the mathematical analysis on the local media library of the user. Alternatively, the selection module 204 can receive the similarity data from a third party. In another embodiment, the selection module 204 determines similarity data by comparing factors relevant to the media object 210a, 210b, 210c. For example, referring to audio tracks, these factors might include, but are not limited to, artist, album, genre, year of recording, geographic region of artist, current touring location of artist, “artist influenced by . . . ,” “artist influences . . . ,” “customers who purchased this track also purchased . . . ”, and “customers who listened to this track also listened to . . . .”

In one embodiment, the ranking module 206 generates a ranking of the media objects 210a, 210b, 210c selected by the selection module 204. The ranking module 206 receives the media objects 210a, 210b, 210c together with their corresponding similarity data, and ranks the media objects 210a, 210b, 210c according to the similarity data.

The output module 208 displays the seed media object together with the media objects 210a, 210b, 210c as a cluster to the user. The media objects 210a, 210b, 210c can be arranged in the cluster according to the ranking, or alternatively in a random manner within the cluster. The output module 208 adapts the size of the cluster to occupy the entire screen of the system or general purpose computing device, or a portion of the screen. Furthermore, the output module 208 can differentiate media objects 210a, 210b, 210c based upon the source. For example, the output module 208 might highlight media objects 210a that are located in the local media library 212. Further, the output module can display media objects 210b stored in the online media library 214 in a different color or opacity than media objects 210a stored in the local media library 212.

FIG. 3 is a schematic block diagram illustrating one embodiment of a system 300 for managing presentation to a client device of a group of media objects. In one embodiment, the system 300 includes a client device 302, a server 304, and a third party server 306. The client device 302 can be a cellular phone, or a personal computer. Other examples of suitable client devices 302 include, but are not limited to, personal media players, laptops, desktop computers, or any other electronic device capable of playing and/or streaming a media object 210.

The client device 302, as depicted, includes the modules 202, 204, 206, 208, of the cluster module 200 of FIG. 2. The client device 302 can also include the local media library 212 of FIG. 2. One of skill in the art will recognize that the client device 302, server 304, and third party server 306 include components and modules as described with reference to the general purpose computing system 100 of FIG. 1, such as a processor, memory, etc., but that are not shown in FIG. 3 for clarity.

In one embodiment, the modules 202, 204, 206, 208 of the cluster module 200 can be distributed amongst various computing devices in an overall data communications network 308. For example, the input module 202 and the output module 208 can be operatively coupled with the client device 302, while the selection module 204 and the ranking module 206 can be operatively coupled with the server 304. As such, the processing requirements related to selecting and ranking media objects 210a, 210b, 210c are “offloaded” from the client device 302 to the server 304.

The client device 302, in one embodiment, communicates with the server 304 over the data communications network 308. The data communications network 308, in one embodiment is the Internet. Alternative examples of data communications network 308 capable of use include, but are not limited to, cellular communication networks, local area networks, wireless local area networks, wide area networks, and direct cable communications such as USB connections.

Alternatively, the client device 302 can operate in an “offline” mode. For example, if the client device 302 is not in communication with the data communications network 308, the selection module 204 of the client device 302 selects media objects 210a from the local media library 212, and the ranking module 206 of the client device 302 ranks the media objects 210a. However, if the client device 302 is in communication with the server 304 over the data communications network 308, the selection module 204 of the server 304 selects the media objects 210b from both the online media library 214 and the local media library 212. For example, the client device 302 can be a personal media player in communication with a desktop computer that acts as the server 304. Alternatively, the personal media player of the example communicates with iTunes®, which acts as the server 304. In a further example, the client device 302 is a desktop computer communicating over the Internet with iTunes®.

The selection module 204, in one embodiment, selects media objects similar to the seed media object from the media library 212 on the client device 302, an online media library 214, or a combination of both. The ranking module 206, in a similar fashion as described above with reference to FIG. 2, ranks the selected media objects 210a, 210b, 210c according to the similarity data with respect to the seed media object. The output module 208 transmits data to the client device 302 for positioning and displaying the selected media objects 210a, 210b, 210c around the seed media object.

FIG. 4 is a schematic block diagram illustrating one embodiment of a cluster 400. The cluster 400, as depicted, can include the seed media object 402, as received by the input module 202 of FIG. 2, and a group of media objects 210a, 210b, 210c positioned around the seed media object 402. As used herein, positioning the media objects around the seed media object 402 refers to not only a radial distribution of media objects around a seed media object, but also can refer to positioning the media objects in the area or vicinity of the seed media object. The system in one aspect presents these objects in different sizes or differentiating features according to the individual rankings.

The output module 208, as described above with reference to FIG. 2, positions the media objects 210a, 210b, 210c around the seed media object 402. The output module 208 can, in one embodiment, equally distribute the media objects 210a, 210b, 210c around the seed media object 402 such that an angle 0 410 between, for example, media objects 210a and 210b is substantially similar to the angle between media objects 210b and 210c. In a further embodiment, the distance between each media object 210a, 210b, 210c and the seed media object 402 can be substantially similar. As such, the output module 208 can position the media objects 210a, 210b, 210c on a perimeter of a circle that is concentric with the seed media object 402.

In one embodiment, a cluster 400 can contain the seed media object 402 and at least one media object 210a, 210b, 210c. Alternatively, the output module 208 of FIG. 2 positions as many media objects 210a, 210b, 210c around the seed media object 402 as allowed by the display device of the user. For example, if the output module 208 is displaying the cluster 400 on a 24″ LCD monitor, the output module 208 will be able to display more media objects 210a, 210b, 210c than on the 3″ screen of a mobile or handheld computing device like a phone or portable media player.

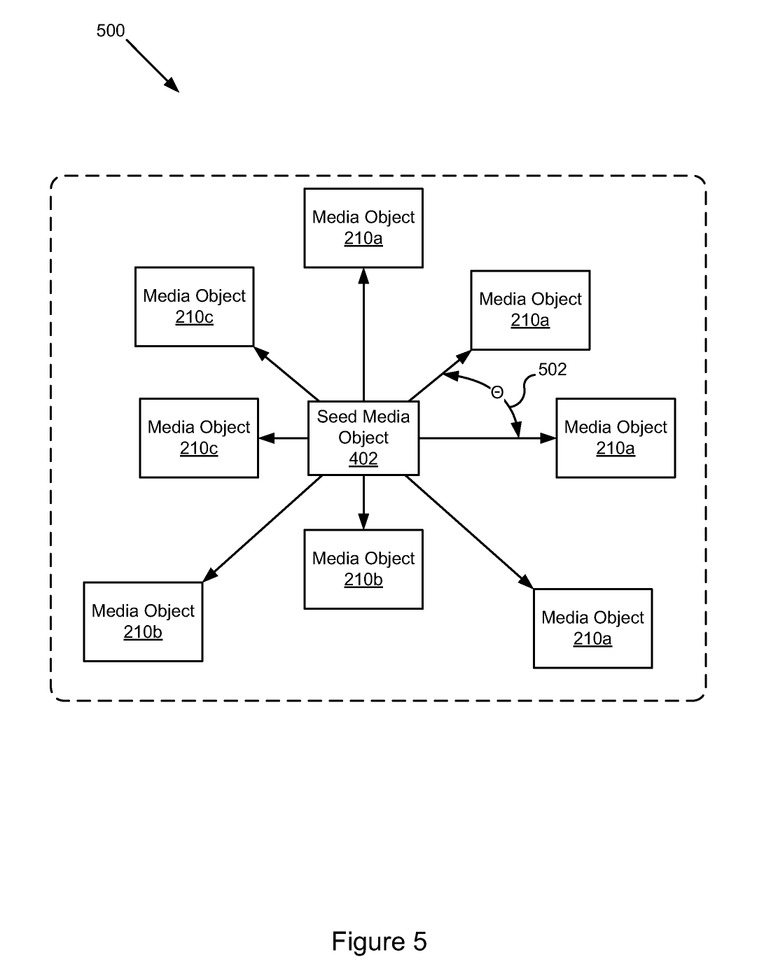

FIG. 5 is a schematic block diagram illustrating another embodiment of a cluster 500. The cluster 500, in one embodiment, can include an asymmetric distribution of media objects 210a, 210b, 210c around the seed media object 402. The output module 208 of FIG. 2 can position the media objects 210a, 210b, 210c around the seed media object 402 according to the strength of the similarity data between each particular media object 210a, 210b, 210c and the seed media object 402. For example, the output module 208 can position a media object 210a having a high similarity with the seed media object 402 closer to the seed media object 402 than a media object 210b with lower ranking.

The output module 208 can select the angle Θ 502 to equally distribute the media objects 210a, 210b, 210c radially around the seed media object 402 as described above with reference to FIG. 4. Alternatively, the output module 208 can select the angle Θ 502 in response to the ranking of the similarity data. For example, the output module 208 selects a small angle Θ 502 between media object 210a and 210b depending on the strength of the similarity data between media object 210a and 210b.

In another embodiment, the output module 208 selects a larger angle Θ 502 between media objects 210b and 210c, each of which can be similar to the seed media object 402 but otherwise have low similarity. For example, if the seed media object 402 was a song that was considered to be “pop-country,” the selection module 204 will have selected media objects 210a, 210b, 210c from both the “pop” genre and the “country” genre. The output module 208, as such, positions the media objects 210a that relate to the “pop” genre closer together with smaller angle Θ 502, in essentially a “mini-cluster.” Likewise, the output module 208 groups the “country” related songs closer together, and separate the “pop” and “country” groupings with a larger angle Θ 502.

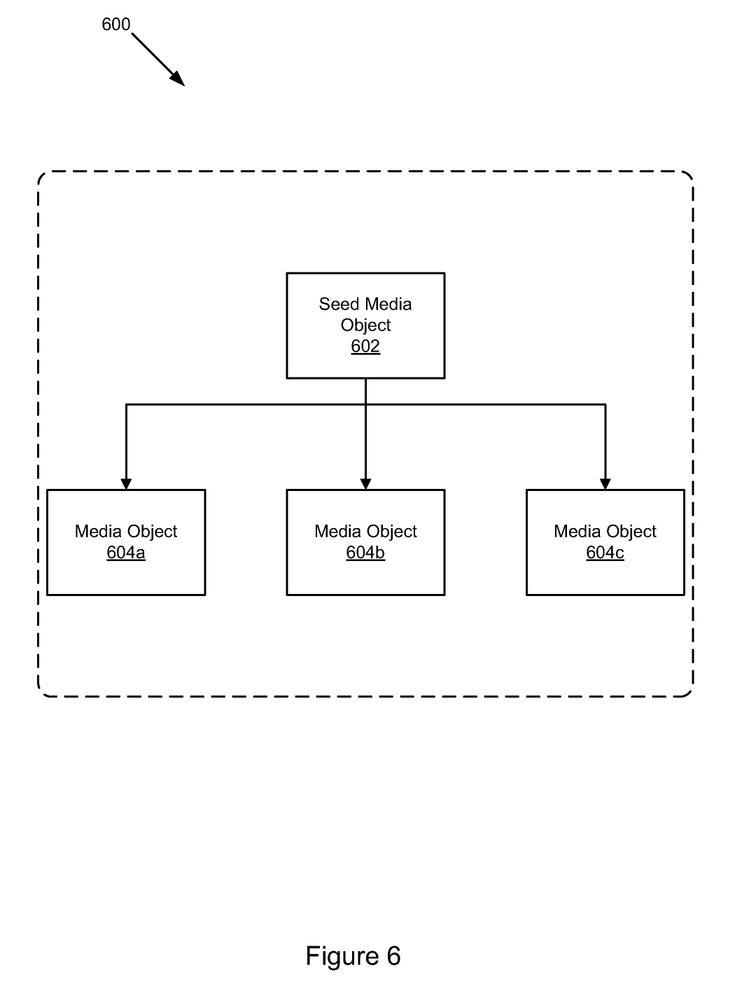

FIG. 6 is a schematic block diagram illustrating another embodiment of a cluster 600. The cluster 600, in one embodiment, includes a seed media object 602 and media objects 604a, 604b, 604c. The output module 208 can position the media objects 604a, 604b, 604c in a non-circular arrangement in the area of the seed media object 602.

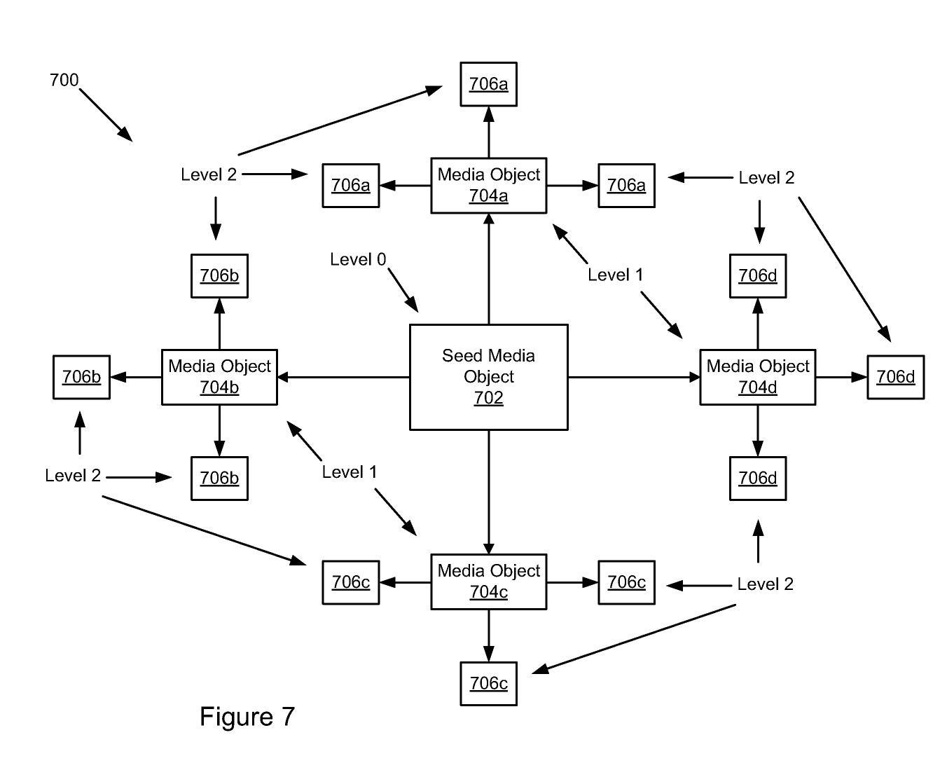

FIG. 7 is a schematic block diagram illustrating another embodiment of a cluster 700. The cluster 700, in one embodiment, includes the seed media object 702, media objects 704a, 704b, 704c, 704d, and media objects 706a, 706b, 706c, 706d. For clarity, the seed media object will be referred to as a level 0 object, media objects 704a, 704b, 704c, 704d, which are directly adjacent the level 0 object will be referred to as level 1 objects, and media objects 706a, 706b, 706c, 706d will be referred to as level 2 objects. In one embodiment, level 0 objects 702 represent the seed media object. Level 1 objects 704a, 704b, 704c, 704d represent media objects selected according to similarity data with the seed media object, and level 2 objects 706a, 706b, 706c, 706d are representative of media objects that are similar to their respective level 1 object 704a, 704b, 704c, 704d.

The output module 208 positions and displays level 2 objects 706a, 706b, 706c, 706d that are related to the level 1 objects 704a, 704b, 704c, 704d as if the level 1 objects 704a, 704b, 704c, 704d themselves were seed media objects. The output module 208 also differentiates between level 0, level 1, and level 2 objects. In one embodiment, the output module 208 differentiates by displaying the level 2 objects 706a, 706b, 706c, 706d with a different opacity than the level 0 object 702 or the level 1 objects 704 such that the level 2 objects 706a, 706b, 706c, 706d appear to a user to be in the background.

Alternatively, the output module 208 can differentiate level 0, level 1, and level 2 objects by modifying the size or color of the media object, or amount of information displayed with the media object. For example, the output module 208 can display the level 0 seed media object 702 with more information than is displayed with either the level 1 or level 2 objects. Information that can be displayed includes, but is not limited to, artist, album, track, genre, filename, year produced, file location, media library source, geographic information of the artist or producer, and similarity data. Consequently, the output module 208 displays level 1 objects 704a, 704b, 704c, 704d with only the artist and album name, and the level 2 objects 706a, 706b, 706c, 706d with only the artist name, for example.

In a further embodiment, the output module 208 differentiates between media objects that are located in the user's local media library and those that are available for previewing or purchasing from an online media library. Examples of such differentiation include, but are not limited to, differences in color, opacity, size, distance from local media objects, and information displayed.

As described above with reference to FIG. 2, the input module 202 receives a user selection of a seed media or level 0 object 702. The input module 202 can also receive the selection of one of the level 1 or level 2 objects as the new level 0 object 702. Examples of a user selection include clicking or double clicking on one of the level 1 or level 2 objects. Alternatively, the input module 202 receives a user selection in the form of the user “dragging” the level 1 or level 2 objects to the position of the level 0 seed media object 702. In a further embodiment, the input module 202 receives the input from a multitude of sources, including but not limited to, controls received from IR or RF remote controls, input through a touch screen, commands sent through SMS or email, or other input received from third party programs and controllers.

The schematic flow chart diagrams included herein are generally set forth as logical flow chart diagrams. As such, the depicted order and labeled steps are indicative of one embodiment of the presented method. Other steps and methods can be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types can be employed in the flow chart diagram, they are understood not to limit the scope of the corresponding method. Indeed, some arrows or other connectors can be used to indicate only the logical flow of the method. For instance, an arrow can indicate a waiting or monitoring period of unspecified duration between enumerated steps of the depicted method. Additionally, the order in which a particular method occurs can or cannot strictly adhere to the order of the corresponding steps shown.

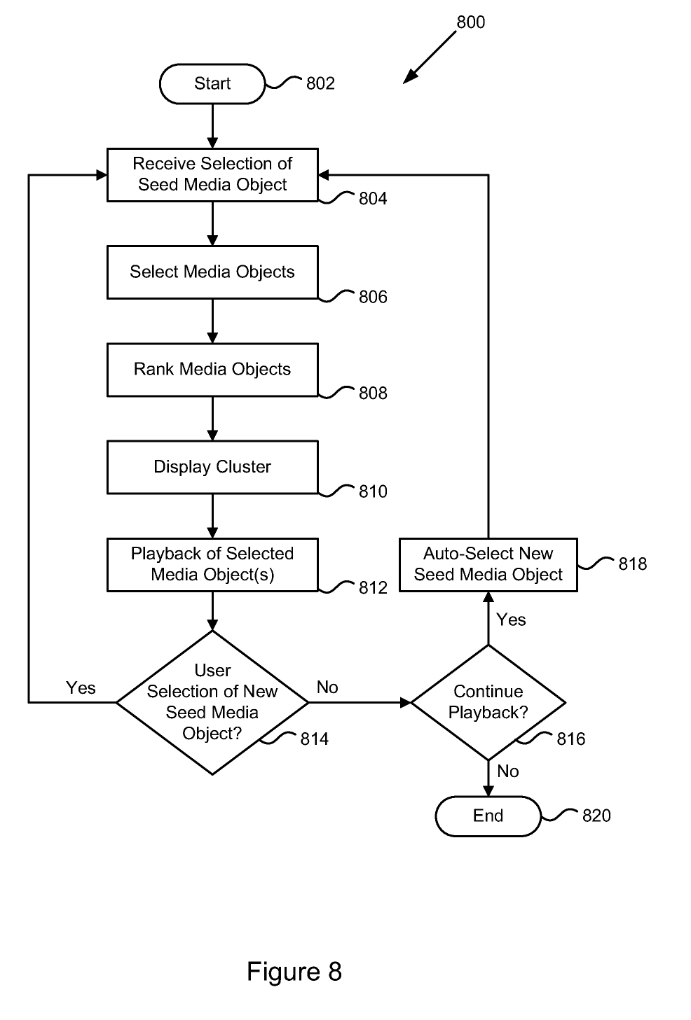

FIG. 8 is a schematic flow chart diagram illustrating one example of a method 800 of clustering media objects. The method 800 starts 802 and the input module 202 receives 804 a user selection as a seed media object. In one embodiment, receiving 804 a user selection can include receiving a click on a media object or, in the case of a touch screen, a “touch.” Alternatively, as described above with reference to FIG. 7, the input module 202 receives the user selection from other programs or sources.

The selection module 204 then selects 806 the media objects. Selecting 806 the media objects, in one embodiment, can include selecting 806 media objects from a local media library, an online media library, or any combination of the local and online media libraries. Furthermore, selecting 806 the media objects includes the selection module 202 selecting 806 media objects according to the similarity data between each media object and the seed media object.

The method 800 continues and the ranking module 206 ranks 808 the media objects. In one embodiment, ranking 808 the media objects includes ordering the media objects according to the similarity data. The ranking module 206 orders the media objects according to the strength of the correlation between each of the media objects and the seed media object.

In another embodiment, the ranking module 206 utilizes other mathematic expressions to calculate the strength of correlation of similarity data between media objects. For example, the ranking module can calculate the strength of correlation by taking into account the percentage of the object's total co-occurrences that is made up by a particular object. In other words, media object A co-occurs with media objects 1 through 5 (not shown) and the media object A's total co-occurrences is the sum of all the co-occurrences with media objects 1 through 5. For example, if media object A co-occurs with object 1 two times, object 2 two times, object 3 two times, object 4 ten times, and object 5 two times, then media object A has 18 total co-occurrences. Therefore, object 4 represents approximately 55% of all of object A's co-occurrences and therefore has a higher strength of correlation with object A than any of the other objects which represent only about 11% of the total of A's co-occurrences. Therefore, in this example, the ranking module 206 orders or ranks 808 object 4 ahead of objects 1, 2, 3, and 5. In the event that objects 1, 2, 3, and 5 have substantially equivalent similarity data, the ranking module 206, in one embodiment, ranks objects 1, 2, 3, and 5 according to the similarity data with object 4

The method 800 continues and the output module 208 displays 810 the media objects. As described above with reference to FIGS. 4-6, the output module 208 displays 810 the media objects in a cluster around the seed media object. The output module 208 can display the media objects in a symmetric configuration with the media objects positioned in a circular configuration, or alternatively, in an asymmetric configuration where the output module 208 displays 810 the media objects according to the strength of correlation between the seed media object and each of the media objects.

In one embodiment, the cluster module 200 then begins playback 812 of selected media objects. The playback can include the entire playlist of the seed media object and the ranked media objects of the media objects. Alternatively, playback 812 can include playing a user selection of the seed media object and the media objects. In another embodiment, if the input module does not receive a user selection, the cluster module 200 can automatically begin playback of the cluster, including the seed media object, in the order determined by the ranking module 206.

The input module 202 can at any time receive 814 a new user selection of a seed media object. Examples of receiving 814 a new seed media object include, but are not limited to, a user clicking on one of the media objects, a user dragging one of the media objects to the position occupied by the old seed media object, and receiving output from a third-party program. If the input module 202 does not receive 814 a new seed media object selection, and the user continues 816 playback, the input module 202 can automatically select 818 one of the media objects to be the new seed media object, and as such, the method 800 continues as described above. If the user does not continue 816 playback, the method 800 ends 820.

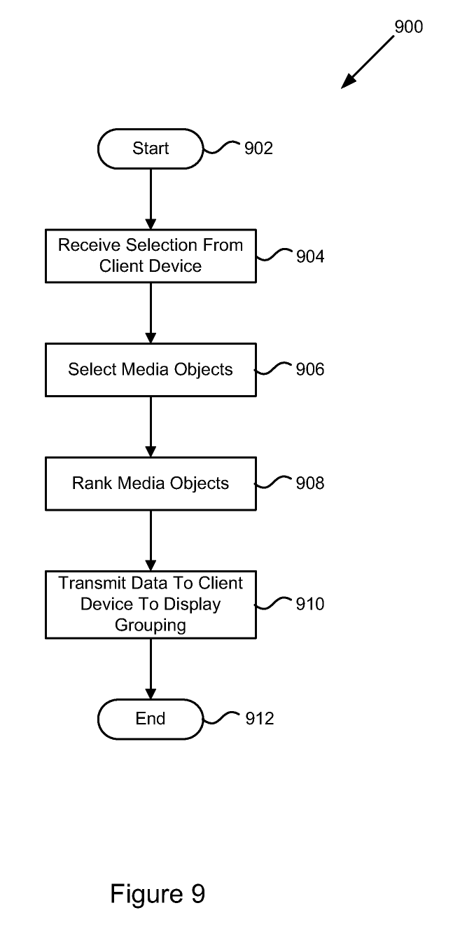

FIG. 9 is a schematic flow chart diagram illustrating one example of a method 900 of managing presentation to a client device of a group of media objects. The method 900 starts 902 and the input module 202 of FIG. 2 receives 904 a selection of a seed media object from a client device. In one embodiment, receiving 904 a selection from a seed media object includes receiving the selection over the data communications network 308 of FIG. 3.

The method 900 continues and the selection module 204 selects a group of media objects from a media library. The selection module 204 selects 906 media objects located on the media library of the client device, from the media library of an online media provider, or a combination of both. The ranking module 206 ranks 908 the media objects according the strength of the similarity data. The output module 208 transmits 910 the selection and ranking data to the client device 302. The method 900 then ends 912.

Embodiments disclosed herein can also include tangible computer-readable media for carrying or having computer-executable instructions or data structures stored thereon. Such computer-readable media can be any available media that can be accessed by a general purpose or special purpose computer, including the functional design of any special purpose processor as discussed above. By way of example, and not limitation, such computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media. Tangible computer-readable media exclude wireless connections or other non-statutory subject matter.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, data structures, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments can be practiced in network computing environments with many types of computer system configurations, including personal computers, hand-held devices, multi-processor systems, microprocessor-based or programmable consumer electronics, network PCs, minicomputers, mainframe computers, and the like. Embodiments can also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various embodiments described above are provided by way of illustration only and should not be construed as limiting. For example, the principles herein can be applied to ranking and displaying data within search results of a web search engine. Those skilled in the art will readily recognize various modifications and changes that can be made to the present disclosure without following the example embodiments and applications illustrated and described herein, and without departing from the true spirit and scope of the disclosed embodiments.

We claim:

1. A method of managing a presentation to and selection of at least one of a group of media objects for a user, the method comprising performing at least one of the following steps:
receiving a user selection of a seed media object;
selecting via a processor a plurality of media objects from a media library based on similarity data between the seed media object and each media object in the plurality of media objects;
generating a ranking of the plurality of media objects according to the similarity data; and
displaying the plurality of media objects in a cluster around the seed media object, wherein each of the plurality of displayed media objects is positioned in the cluster according to the ranking and relative to the seed media object.

2. The method of claim 1, further comprising:
receiving a user selection of at least one of the plurality of displayed media objects; and
displaying a new cluster of media objects around the selection, wherein the user selected media object becomes a new seed media object and the media objects of the new cluster are selected and ranked based on the similarity data between the new seed media object and the media objects of the new cluster.

3. The method of claim 2, further comprising playing the user selected media object.

4. The method of claim 1, wherein similarity data is generated based upon a determined incidence of co-occurrence of pairs of individual media objects across a plurality of user media libraries.

5. The method of claim 4, wherein the similarity data is received from an online data processing center.

6. The method of claim 1, wherein selecting the plurality of media objects comprises selecting media objects from a user media library.

7. The method of claim 1, wherein selecting the plurality of media objects comprises selecting media objects from an online media provider.

8. The method of claim 1, wherein selecting the plurality of media objects comprises selecting media objects from a user media library and from an online media provider.

9. The method of claim 1, wherein positioning each of the plurality of media objects further comprises selecting a distance and angle with respect to the seed media object, the distance and angle selected according to the ranking.

10. The method of claim 1, further comprising playing the playlist.

11. The method of claim 1, wherein the media library further comprises a user media library and an online media library and wherein the displayed plurality of media objects in the cluster identifies which media objects are from the user library and which media objects are from the online media library.

12. A system to manage presentation to a client device of at least one of a group of media objects for a user, the system comprising:
a processor;
an input module configured to control the processor to select a seed media object based on data from a client device;
a selection module configured to control the processor to select a plurality of media objects from a media library based on similarity data between the seed media object and each media object in the plurality of media objects;
a ranking module configured to control the processor to generate a ranking of the plurality of media objects according to the similarity data; and
an output module configured to control the processor to transmit data to the client device for display of the plurality of media objects in a group around the seed media object, wherein each of the plurality of displayed media objects is distributed in a radial configuration around the seed media object.

13. The system of claim 12, wherein the media library comprises media objects in a user media library and an online media provider media library.

14. The system of claim 12, wherein the input module is further configured to receive an identification from the user of a desire to receive at least one media object displayed in the cluster from the online media library.

15. The system of claim 14, wherein the output module is further configured to transmit the identified at least one media object from the online media library to the user media library.

16. The system of claim 12, wherein the ranking module is further configured to generate a playlist formed of the seed media object and the plurality of media objects, wherein the seed media object and the plurality of media objects are ordered within the playlist according to the ranking.

17. A computer program product comprising a tangible computer-readable medium having computer executable instructions to perform operations for managing a presentation to and selection of at least one of a group of media objects for a user, the operations of the computer program product comprising:
receiving a user selection of a level 0 object, the level 0 object comprising a seed media object;
displaying a plurality of level 1 objects adjacent the level 0 object, wherein each level 1 object is selected from a media library based on similarity data between the level 0 object and the level 1 object;
displaying a plurality of level 2 objects adjacent each level 1 object, wherein each level 2 object is selected from the media library based on similarity data between the level 1 object and each respective level 2 object in the plurality; and
differentiating between the level 0 object, level 1 objects, and level 2 objects.

18. The computer program product of claim 17, wherein differentiating between the level 0 object, level 1 objects, and level 2 objects further comprises:
displaying the level 0 object with a size larger than the level 1 objects; and
displaying the level 1 objects with a size larger than the level 2 objects.

19. The computer program product of claim 17, wherein differentiating between the level 0 object, level 1 objects, and level 2 objects further comprises:
displaying the level 0 object with a higher opacity than the level 1 objects; and
displaying the level 1 objects with a higher opacity than the level 2 objects.

20. The computer program product of claim 17, wherein differentiating between the level 0 object, level 1 objects, and level 2 objects further comprises:
displaying the level 0 object with a different color than the level 1 objects; and
displaying the level 1 objects with a different color than the level 2 objects.

21. The computer program product of claim 17, wherein differentiating between the level 0 object, level 1 objects, and level 2 objects further comprises:
displaying more media object information about the level 0 object relative to an amount of information displayed for the level 1 objects; and
displaying more media object information about the level 1 objects relative to an amount of information displayed for the level 2 objects.

22. The computer program product of claim 21, wherein the media object information consists of artist, title, filename, genre, year produced, file location, media library source, geographic information of the artist, and similarity data.

23. The computer program product of claim 17, wherein the operations for managing a presentation to and selection of at least one group of media objects further comprise:
displaying a list of media objects ranked according to similarity data between the level 0 object and the level 1 objects, and the similarity data between level 1 objects and respective level 2 objects.
